(19) United States
(12) Patent Application Publication
(10) Pub. No.: US 2025/0049624 A1
(43) Pub. Date: Feb. 13, 2025

(54) Operating table and supporting structure

(71) Applicant: NANJING MINDRAY BIO-MEDICAL ELECTRONICS CO., LTD., Nanjing (CN)

(72) Inventors: Yunfang LIANG, Nanjing (CN); Xingwei JIN, Nanjing (CN); Hongbing ZHANG, Nanjing (CN)

(73) Assignee: NANJING MINDRAY BIO-MEDICAL ELECTRONICS CO., LTD., Nanjing (CN)

(21) Appl. No.: 18/930,925

(22) Filed: Oct. 29, 2024

Related U.S. Application Data
(63) Continuation of application No. PCT/CN2023/092101, filed on May 4, 2023.

(30) Foreign Application Priority Data
Apr. 29, 2022 (WO) PCT/CN2022/090814

(51) Int. Cl. A61G 13/08

(52) U.S. Cl. CPC A61G 13/08

(57) ABSTRACT

Provided are a surgical table and a supporting structure. The surgical table includes a supporting platform, a holding component, a supporting assembly, a releasing component, and a limiting component. The holding component is rotatably installed on the supporting platform in a vertical direction. The supporting assembly is provided at the bottom of the holding component, and includes a first installation end rotatably connected to the supporting platform and a second installation end movably connected to the holding component. A release button is provided at the second installation end of the supporting assembly, and the releasing component is movably connected to the second installation end When the holding component overturns relative to the supporting platform as the holding component is acted upon by a force, the limiting component drives the releasing component to move relative to the second installation end to trigger the release button.

### CROSS-REFERENCE TO RELATED APPLICATIONS

This disclosure is a bypass continuation of Patent Cooperation Treaty Application No. PCT/CN2023/092101, filed on May 4, 2023, which claims the benefit of Patent Cooperation Treaty Application No. PCT/CN2022/090814, filed on Apr. 29, 2022, the content of both of which are incorporated herein by reference in its entirety.

### TECHNICAL FIELD

The disclosure relates to an equipment field of medical device, and more particularly to a surgical table and a supporting structure.

### BACKGROUND

To meet the clinical requirements, the surgical table needs to match different modules or accessories, and these modules or accessories need to achieve multi-angle adjustment, for example, the leg plate of the surgical table need to be capable of being adjusted in multiple angles. Currently, the surgical table often uses gear mechanism or ratchet mechanism to achieve angle adjustment of modules or accessories, which are structurally complex and require the adjuster to move within an operable range to perform adjustments, resulting in low operational convenience.

### SUMMARY

In view of this, this disclosure provides a surgical table and a supporting structure.

In the first aspect of this disclosure, a surgical table is provided, including:
a supporting platform that is a main body for the surgical table;
a holding component, which is rotatably installed on the supporting platform;
a supporting assembly, which is provided at a bottom of the holding component, and the supporting assembly includes a first installation end and a second installation end, wherein the first installation end is rotatably connected to the supporting platform and the second installation end is movably connected to the holding component, and a release button is provided at the second installation end of the supporting assembly, wherein when the release button is not triggered, the supporting assembly is used to support the holding component, so that the holding component and the supporting platform remain fixed, and when the release button is triggered by an external force, the supporting assembly is extendable or retractable, so that the holding component is rotatable relative to the supporting platform;
a releasing component, which is movably connected to the second installation end, wherein when an external force is applied to the releasing component, the releasing component moves relative to the second installation end to trigger the release button; and
a limiting component, which is installed on the holding component;
wherein when the holding component overturns relative to the supporting platform as the holding component is acted upon by a force, the limiting component contacts and drives the releasing component to move relative to the second installation end so as to trigger the release button.

In the second aspect of this disclosure, a supporting structure is provided, including:
a main body;
a holding component, which is rotatably installed on the main body;
a supporting assembly, which is provided at the bottom of the holding component, and the supporting assembly includes a first installation end and a second installation end, wherein the first installation end is rotatably connected to the main body and the second installation end is movably connected to the holding component, and a release button is provided at the second installation end of the supporting assembly, wherein when the release button is not triggered, the supporting assembly is used to support the holding component, so that the holding component and the main body remain fixed, and when the release button is triggered by an external force, the supporting assembly is extendable or retractable, so that the holding component is rotatable relative to the main body;
a releasing component, which is movably connected to the second installation end, wherein when an external force is applied to the releasing component, the releasing component moves relative to the second installation end to trigger the release button; and
a limiting component, which is installed on the holding component;
wherein when the holding component overturns upwards relative to the main body as the holding component is acted upon by a force, the limiting component contacts and drives the releasing component to move relative to the second installation end so as to trigger the release button.

It can be seen from the above technical solutions that the first aspect of this disclosure proposes a surgical table, in which a release button is provided at the supporting assembly, and the releasing component is movably connected to the second end of the supporting assembly. The release button can be triggered when an external force is applied to the releasing component, allowing the supporting assembly to freely extend or retract, and thus the angle of the holding component relative to the supporting platform can be adjusted. The adjustment mechanism is relatively simple in structure, has high reliability, and is more convenient and practical to adjust, compared with the adjustment mechanisms of the existing gear mechanism or ratchet mechanism. In addition, the second installation end of the supporting assembly is movably connected to the holding component, and the releasing component is movably connected to the second installation end. When the holding component overturns upwards as the holding component is acted upon by a force, the second installation end and the holding component will be moved relatively, and the limiting component contacts and drives the releasing component to move to trigger the release button, so as to adjust the angle of the holding component. In this way, the operator can stand at any position where can access the holding component, and overturn upwards the holding component to achieve the adjustment of the holding component, offering greater flexibility and higher convenience in operation.

### BRIEF DESCRIPTION OF THE DRAWINGS

To more clearly illustrate the technical solutions of the embodiments of the disclosure, a brief introduction to the accompanying drawings required in the description of the embodiments will be provided below. Obviously, the drawings in the description below are of some embodiments of the disclosure. For a person of ordinary skill in the art, other drawings similar to the above can be obtained without the expenditure of inventive efforts.

FIG. 1 is a structural diagram of the surgical table according to an embodiment of the disclosure;

FIG. 2 is an assembly diagram of the supporting platform, the holding component, the supporting assembly, the releasing component, and the limiting component according to an embodiment of the disclosure;

FIG. 3 is a schematic diagram illustrating the assembly of the holding component, the supporting assembly, the releasing component and the limiting component according to an embodiment of the disclosure;

FIG. 4 is a schematic diagram illustrating the assembly of the releasing component and the limiting component when the holding component is overturned upwards according to an embodiment of the disclosure;

FIG. 5 is a schematic diagram of the triggering part triggering the release button when the holding component is overturned upwards according to an embodiment of the disclosure;

FIG. 6 is a schematic diagram illustrating the assembly of the holding component, the supporting assembly, the releasing component and the limiting component according to an embodiment of the disclosure;

FIG. 7 is a partial structure diagram of the second installation end of the supporting assembly, the releasing component, the limiting component, and the holding component according to an embodiment of the disclosure;

FIG. 8 is a partial structure diagram of the second installation end of the supporting assembly, the releasing component, the limiting component, and the holding component according to another embodiment of the disclosure;

FIG. 9 is a schematic diagram of the releasing component being rotated upwards according to an embodiment of the disclosure;

FIG. 10 is a schematic diagram of the triggering part triggering the release button when the releasing component is rotated upwards according to an embodiment of the disclosure;

FIG. 11 is a schematic diagram of the triggering part triggering the release button when the releasing component is pushed to the right according to an embodiment of the disclosure.

### DETAILED DESCRIPTION

The technical solutions in the embodiments of the disclosure are described clearly and completely in the following with reference to the drawings. It is evident that the described embodiments are only a part rather than all of the embodiments of the disclosure. All other embodiments obtained by a person of ordinary skill in the art based on the embodiments of the disclosure without creative efforts are within the scope of protection of the disclosure.

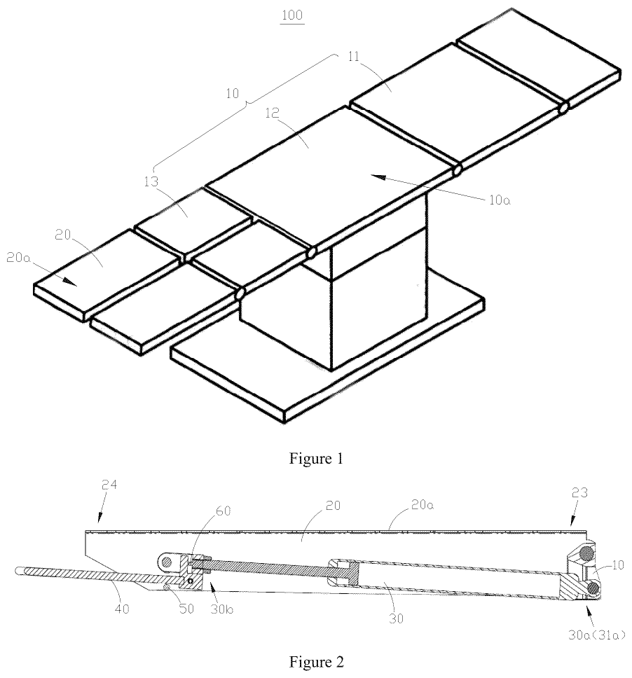

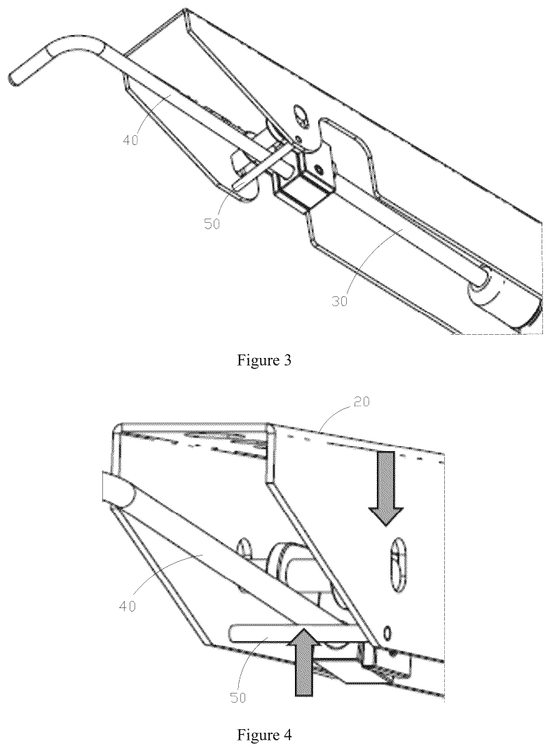

As shown in FIGS. 1 to 3, an embodiment of the disclosure provides a surgical table 100, the surgical table 100 includes a supporting platform 10 that is a main body for the surgical table 100, a holding component 20, a supporting assembly 30, a releasing component 40, and a limiting component 50. The supporting platform 10 has a supporting surface 10a for supporting the patient. For example, the supporting platform 10, which constitutes a main body for the surgical table 100 may include, but is not limited to, the supporting platform composed of a back supporting plate 11, a lumbar supporting plate 12, and a thigh supporting plate 13 for supporting the patient's back, lumbar part, and thigh. The back supporting plate 11, the lumbar supporting plate 12, and the thigh supporting plate 13 can either be three rotationally connected supporting plates, or a complete supporting plate which is divided into three parts, namely the back supporting plate 11, the lumbar supporting plate 12, and the thigh supporting plate 13, specifically according to actual design requirements.

The holding component 20 is rotatably installed on the supporting platform 10 along the vertical direction, with its upper surface constituting the holding surface 20a. The term “vertical direction” refers to the orientation of the surgical table 100 during normal operation. Optionally, the holding component 20 may be, but is not limited to, the head supporting plate, the leg supporting plate, or the arm supporting plate. The patient's head, leg, or arm can be adjusted to a position comfortable for the patient or convenient for surgery by rotating the holding component 20.

The supporting assembly 30 is provided at the bottom of the holding component 20. The supporting assembly 30 includes a first installation end 30a and a second installation end 30b. The first installation end 30a is rotatably connected to the supporting platform 10, and the second installation end 30b is movably connected to the holding component 20. A release button 60 is provided at the second installation end 30b of the supporting assembly 30. When the release button 60 is not triggered, the supporting assembly 30 is used to support the holding component 20, so that the holding component 20 and the supporting platform 10 remain fixed. When the release button 60 is triggered by an external force, the supporting assembly 30 is extendable or retractable, so that the holding component 20 is rotatable relative to the supporting platform 10. The moveable connection between the second installation end 30b and the holding component 20 implies that there is relative displacement capability between the two. For example, the second installation end 30b and the holding component 20 may be relatively displaced in a direction perpendicular to the holding surface 20a, or the second installation end 30b and the holding component 20 may be relatively displaced in the direction of extension of the holding component 20.

The releasing component 40 is movably connected to the second installation end 30b. When an external force is applied to the releasing component 40, the releasing component 40 moves relative to the second installation end 30b to trigger the release button 60. The movable connection between the releasing component 40 and the second installation end 30b means that the releasing component 40 and the second installation end 30b may be relatively displaced, or the releasing component 40 and the second installation end 30b may be relatively rotated. For example, the releasing component 40 and the second installation end 30b may be relatively displaced in the direction of extension of the holding component 20.

The limiting component 50 is installed on the holding component 20. When the holding component 20 overturns relative to the supporting platform 10 as the holding component 20 is acted upon by a force, the limiting component 50 contacts and drives the releasing component 40 to move relative to the second installation end 30b to trigger the release button 60.

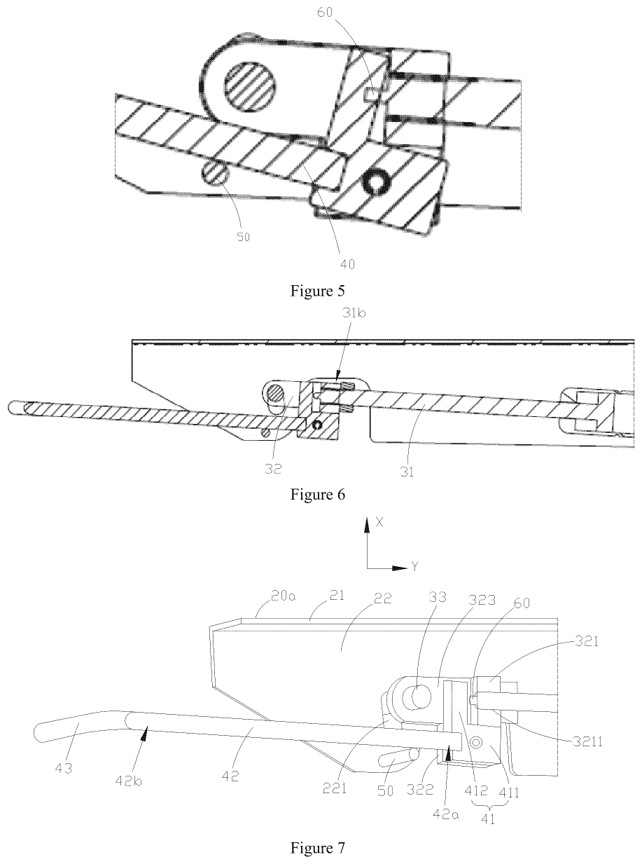

As shown in FIGS. 1 to 5, as an example, the second installation end 30b and the holding component 20 may be relatively displaced in a direction perpendicular to the holding surface 20a, and the releasing component 40 and the second installation end 30b may be relatively rotated. The adjustment process of the holding component 20 is as follows: The operator grasps the edge of the holding component 20 and turns the holding component 20 upwards relative to the supporting platform 10, and the limiting component 50 moves upwards with the holding component 20. During this process, the second installation end 30b of the supporting assembly 30 moves downwards relative to the holding component 20 due to gravity, and the releasing component 40 moves downwards relative to the holding component 20 with the second installation end 30b of the supporting assembly 30, until the limiting component 50 is pressed against the releasing component 40, and the releasing component 40 rotates under the pressed against the limiting component 50, thus triggering the release button 60. The supporting assembly 30 is freely extendable or retractable, so that the holding component 20 can always overturn upwards. After the holding component 20 is turned to the designated position, the operator loosens the holding component 20. The holding component 20 turns downwards due to gravity. During the process of overturning, the limiting component 50 loosens the releasing component 40, and the supporting assembly 30 is locked in length, so that the holding component 20 and the supporting platform 10 remain fixed, and thus the holding component 20 remains in the designated position.

The surgical table 100 is provided in the embodiment of the disclosure. The release button is provided at the supporting assembly, and the releasing component is movably connected to the second end of the supporting assembly. The release button can be triggered when an external force is applied to the releasing component, allowing the supporting assembly to freely extend or retract, and thus the angle of the holding component relative to the supporting platform can be adjusted. The adjustment mechanism is relatively simple in structure, has high reliability, and is more convenient and practical to adjust, compared with the adjustment mechanisms of the existing gear mechanism or ratchet mechanism. In addition, the second installation end of the supporting assembly is movably connected to the holding component, and the releasing component is movably connected to the second installation end. When the holding component overturns upwards as the holding component is acted upon by a force, the second installation end and the holding component will be moved relatively, and the limiting component contacts and drives the releasing component to move to trigger the release button, so as to adjust the angle of the holding component. In this way, the operator can stand at any position where the holding component can be touched, and overturn upwards the holding component to realize the adjustment of the holding component. The operation is more flexible and convenient.

As shown in FIG. 2 and FIG. 6, in some embodiments, the supporting assembly 30 includes a pneumatic supporting member 31 and an installation base 32. The pneumatic supporting member 31 includes a first end 31a and a second end 31b opposite to the first end 31a. The first end 31a of the pneumatic supporting member 31 is rotatably connected to the supporting platform 10, and the release button 60 is provided at the second end 31b of the pneumatic supporting member 31. The installation base 32 is connected to the second end 31b of the pneumatic supporting member 31, and the installation base 32 is movably installed to the holding component 20. It should be noted that, the supporting assembly 30 is not limited to the pneumatic supporting member 31. For example, in some other embodiments, the supporting assembly 30 may be provided with an electric supporting column or a hydraulic supporting column, which may be determined according to actual design requirements.

As shown in FIG. 2 and FIG. 7, in some embodiments, the second installation end 30b is movably installed to the holding component 20 along the first direction X. The releasing component 40 is rotatably installed to the second installation end 30b, the limiting component 50 is located at the bottom of the releasing component 40, and the first direction X is perpendicular to the holding surface 20a. When the holding component 20 overturns upwards relative to the supporting platform 10 as the holding component 20 is acted upon by a force, the limiting component 50 contacts and drives the releasing component 40 to rotate relative to the second installation end 30b to trigger the release button 60. For the adjustment process of the holding component 20, see the descriptions above.

For instance, a holding component 20 includes a holding plate 21 and a side plate 22 provided at the bottom of the holding plate 21. The upper surface of the holding plate 21 is the holding surface 20a. The side plate 22 is provided with a first installation hole 221, the second installation end 30b is provided with a first installation column 33, the first installation column 33 is provided through the first installation hole 221. The first installation hole 221 is an elongated hole extending along the first direction X, so that the first installation column 33 is movable along the first direction X.

When the release button 60 is not triggered, the first installation column 33 at the second installation end 30b of the supporting assembly 30 is supported on the hole wall of the first installation hole 221 and exerts force on the hole wall, thus counterbalancing the gravitational force of the holding component 20 and supporting the holding component 20.

Specifically, the holding component 20, when at rest or with a patient lying on top of it, will swing downward relative to the supporting platform 10 due to gravity until the top wall of the first installation hole 221 is pressed against the first installation column 33. The first installation column 33 forms an upward component force on the holding component 20, so that the holding component 20 stops swing downward under the restriction of the first installation column 33. When the operator lifts the holding component 20, the holding component 20 swings upwards a little relative to the supporting platform 10. Synchronously, the limiting component 50 swings upwards a little with the holding component 20. The supporting assembly 30 moves downwards along the first installation hole 221 due to gravity. Synchronously, the releasing component 40 moves downwards with the supporting assembly 30 until the limiting component 50 is pressed against the releasing component 40. The limiting component 50 drives the releasing component 40 to trigger the release button 60. At this time, the supporting assembly 30 is extendable or retractable, and the holding component 20 swings a lot to the designated position.

The elongated hole can be waist-shaped hole, arc hole, etc.

It should be noted that the extending along the first direction X is not limited to extending in a straight line along the first direction X as shown in the figure. The first installation hole 221 may extend at an angle relative to the first direction X, with a height differential between its first and second ends. The closer to the rotary center of the triggering part 41 (refer to FIG. 7), the farther the first installation hole 221 is away from the upper surface of the holding plate 21. Correspondingly, the first direction X is the direction extending at an angle relative to the holding surface 20a. More preferably, the first installation hole may be a curved hole, the center of which may be the rotational connection point between the holding component 20 and the supporting platform 10, and correspondingly, the first direction X is along the arc of a circular centered at the pivot point where the holding component 20 is hinged to the supporting platform 10. It should be noted that the shape of the first installation hole 221 is not limited to the above mentioned forms, as long as it allows the first installation column 33 move and close to or away from the holding surface 20a during the movable process.

It should be noted that the positions of the first installation hole 221 and the first installation column 33 are interchangeable, depending on the actual design requirements. That is, the first installation hole 221 is provided at the second installation end 30b, and the first installation column 33 is provided at the side plate 22, which may be determined.

It should be noted that the second installation end 30b can be movably installed to the holding component 20 along the first direction X and is not limited to the use of the first installation hole 221 and the first installation column 33 mentioned above. For example, in some other embodiments, one of the side plate 22 and the second installation end 30b is provided at a slide rail or a slide groove extending along the first direction X, and the other of the side plate 22 and the second installation end 30b is provided at a sliding component which can slide into the slide rail or the slide groove.

Alternatively, the installation base 32 includes the base 321, the installation part of the triggering part 322, and the installation part of the installation column 323. The base 321 is provided with an installation hole 3211. The second end 31b of the pneumatic supporting member 31 is threaded through the installation hole 3211 and is secured relative to the installation hole 3211. The release button 60 is exposed on the side of the base 321 opposite to the supporting platform 10. There are two installation parts of the triggering part 322. The two installation parts of the triggering part 322 are provided at intervals at the bottom of the base 321. The releasing component 40 includes the triggering part 41. The installation part of the triggering part 322 is rotatably installed between the two installation parts of the triggering part 322. There are two installation parts of the installation column 323. The two installation parts of the installation column 323 are provided at intervals at the side of the base 321 opposite to the supporting platform 10. The first installation column 33 is threaded through the two installation parts of the installation column 323. Of course, the number of the installation part of the triggering part 322 and the installation part of the installation column 323 is not limited to two, or one, the installation positions of the installation part of the triggering part 322 and the installation part of the installation column 323 are not limited to the above methods, or they can be installed on other positions of the base 321 according to the actual design requirements.

Alternatively, the triggering part 411 includes the body 411 and the pressing part 412. The body 411 is rotatably installed between the two installation parts of the triggering part 322, and the pressing part 412 is installed on the top side of the body 411 and opposite to the release button 321. When the body 411 rotates, the pressing part 412 rotates towards the base 321 along with the body 411 until it contacts and triggers the release button 322.

Alternatively, the releasing component 40 also includes a rod part 42, the rod part 42 includes a first end 42a and a second end 42b opposite to the first end 42a. The first end 42a of the rod part 42 is connected to the trigger part 41, and the limiting component 50 is installed on the bottom of the rod part 42. Optionally, the limiting component 50 is a supporting column installed on the side plate 22. When the holding component 20 overturns upwards, the supporting column moves upwards along with the holding component 20. The upwards moving supporting column contacts the rod part 42, and the rod part 42 drives the triggering part 41 to rotate so as to trigger the release button 60.

Alternatively, the releasing component 40 further includes an operating part 43, the operating part 43 is connected to the second end 42b of the rod part 42, and manual operation of the operating part 43 is capable of driving the triggering part 41 to trigger the release button 60. In this way, the holding component 20, in addition to be adjusted the angle by overturning the holding component upwards mentioned above, can also be adjusted by the manual operation of the operating part 43 in the present embodiment, which enhance the convenience of adjustment. It should be noted that in the illustrated embodiment, by overturning the holding component 20 upwards, the holding component 20 can only be upwards, and by the manual operation of the operating part 43, the holding component 20 can be upwards or downwards.

As shown in FIG. 2 and FIG. 7, optionally, the holding component 20 includes a first connecting end 23 and a first free end 24, the first connecting end 23 is rotatably connected to the supporting platform 10, and the operating part 43 is located at the bottom of the first free end 24. In this way, the operating part 43 is convenient for manually operating. Specifically, when the operating part 43 is operated, the operator can place the four fingers on the upper surface of the first free end 24, place the thumb on the bottom of the operating part 43, and then press the operating part 43 to the first free end 24 by grasping the operating part 43 to trigger the release button 60. This process requires only one-handed operation for convenience.

It should be noted that, the aforementioned method is not the only approach. For example, in some other embodiments, the surgical table 100 also includes a top plate installed on the top of the holding component 20, the top plate includes a second connecting end and a second free end, the second connecting end is connected to the holding component 20, and the operating part 43 is located at the bottom of the second free end. Given that the holding component 20 serves as both a connecting part and a supporting part, it is essential for it to possess high strength, typically achieved by manufacturing it from metal materials. If the overall design of the holding component 100 is designed to be relatively long, this could result in a surgical table 100 with a substantial weight. In this embodiment, the weight can be effectively reduced by providing the top plate made of plastic or carbon fiber material. The operating part 43 located at the bottom of the second free end can be referred to the above embodiments.

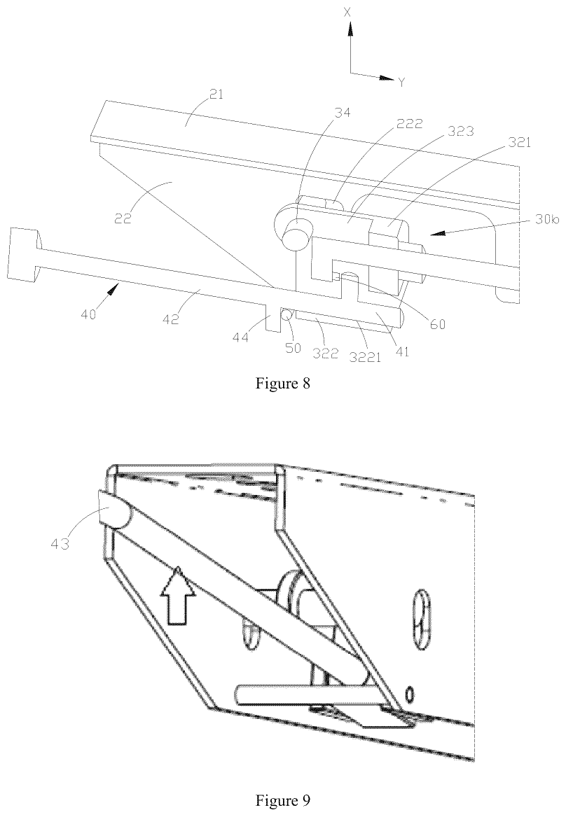

In the above embodiment, the second installation end 30b is movably installed on the holding component 20 along the first direction X. It should be noted that the second installation end 30b is not limited to the above method. For example, in some other embodiments, as shown in FIG. 8, the second installation end 30b is moveably installed on the holding component 20 along the second direction Y. The releasing component 40 is slidably installed on the second installation end 30b along the second direction Y. The second direction Y is the direction in which the first connecting end 23 extends towards the first free end 24.

Optionally, the releasing component 40 includes the triggering part 41 and the protruding part 44. The triggering part 41 is slidably installed on the second installation end 30b along the second direction Y, the protruding part 44 is connected to the triggering part 41, and the limiting component 50 is installed on the side of the protruding part 44 towards the supporting platform 10.

In this embodiment, the adjustment process of the holding component 20 is as follows: The operator grasps the edge of the holding component 20 and turns the holding component 20 upwards relative to the supporting platform 10. During the process of overturning the holding component 20 upwards, the second installation end 30b of the supporting assembly 30 moves along the second direction Y towards the supporting platform 10 relative to the holding component 20. The limiting component 50 contacts the protruding part 44 and drives the releasing component 40 to move along the second direction Y away from the supporting platform 10 until the triggering part 41 triggers the release button 60. The supporting assembly 30 is freely extendable or retractable. At this time, the supporting assembly 30 can be always turned upwards. After the holding component 20 turns to the designated position, the operator loosens the holding component 20, and the holding component 20 turns downwards due to gravity. During the process of the holding component 20 overturning downwards, the limiting component 50 loosens the releasing component 40, and the length of the supporting assembly 30 is locked, so that the holding component 20 and the supporting platform 10 remain fixed, and thus the holding component 20 is kept in its designated position.

It should be noted that the release button 60 in the preceding embodiment is installed opposite to the supporting platform 10. In this embodiment, the release button 60 can be installed towards the supporting platform 10. Because the process of the holding component 20 overturning upwards, the releasing component 40 moves away from the supporting platform 10 along the second direction Y, the release button 60 can be installed towards the supporting platform 10, and the releasing component 40 can directly press the release button 60, and thus the structure is simple.

Of course, the release button 60 in this embodiment may be installed opposite to the supporting platform 10, while in the above embodiment it is installed facing towards the supporting platform 10. In adopting this design scheme, the second installation end 30b of the supporting assembly 30 needs to install a transmission mechanism, and the transmission mechanism is connected to the releasing component 40. When the releasing component 40 moves away from the supporting platform 10 along the second direction Y, it drives transmission mechanism to move towards the supporting platform 10 along the second direction Y to press the release button 60. Optionally, the transmission mechanism adopts a connecting rod mechanism or a cam mechanism.

Alternatively, the holding component 20 includes a holding plate 21 and a side plate 22 provided at the bottom of the holding plate 21. The side plate 22 is provided with a second installation hole 222, the second installation end 30b is provided with a second installation column 34, the second installation column 34 is provided through the second installation hole 222, the second installation hole 222 is an elongated hole extending along the second direction Y, so that the second installation column 34 is movable along the second direction Y.

It should be noted that the positions of the second installation hole 222 and the second installation column 222 are interchangeable, that is, the second installation hole 222 is provided at the second installation end 30b, and the second installation column 222 is provided at the side plate 22, which may be determined according to actual design requirements.

It should be noted that the second installation end 30b can be movably installed to the holding component 20 along the second direction Y and is not limited to the use of the second installation hole 222 and the second installation column 34 mentioned above. For example, in some other embodiments, one of the side plate 22 and the second installation end 30b is provided at a slide rail or a slide groove extending along the second direction Y, and the other of the side plate 22 and the second installation end 30b is provided at a sliding component which can slide into the slide rail or the slide groove.

Alternatively, the installation base 32 includes the base 321, the installation part of the triggering part 322, and the installation part of the installation column 323. The second end 31b of the pneumatic supporting member 31 is installed on the base 321. The installation part of the triggering part 322 is installed on the bottom of the base 321. The installation part of the triggering part 322 is provided with a hole 3221. The triggering part 3221 is slidably threaded through the hole 3221. There are two installation parts of the installation column 323. The two installation parts of the installation column 323 are provided at intervals at the side of the base 321 opposite to the supporting platform 10. The first installation column 33 is threaded through the two installation parts of the installation column 323. Of course, the number of the installation part of the installation column 323 is not limited to two, or one, the installation positions of the installation part of the installation column 323 are not limited to the above methods, or they can be installed on other positions of the base 321 according to the actual design requirements.

Alternatively, the releasing component 40 also includes a rod part 42, the rod part 42 includes a first end 42a and a second end 42b opposite to the first end 42a. The first end 42a of the rod part 42 is connected to the triggering part 41, the protruding part 44 is installed on the bottom of the rod part 42, and the limiting component 50 is installed on the bottom of the rod part 42. In this embodiment, the limiting component 50 can support the releasing component 40. The connection between other components in this embodiment can be referred to the above embodiment, and details are not described herein.

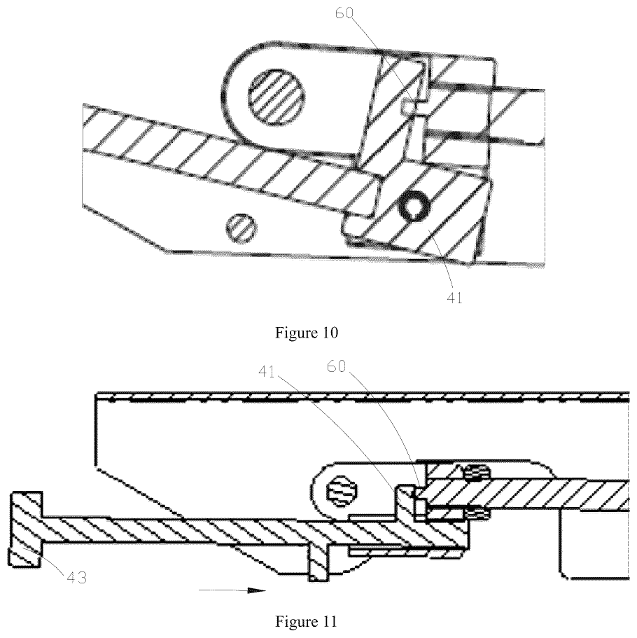

As shown in FIG. 7, FIG. 9 and FIG. 10, in some embodiments, the releasing component 40 includes a triggering part 41 and an operating part 43, the triggering part 41 is movably connected to the second installation end 30b, and the operating part 43 is connected to the triggering part 41. Manual operation of the operating part 43 is capable of driving the triggering part 41 to trigger the release button 60. In this way, the holding component 20, in addition to be adjusted the angle by overturning the holding component upwards mentioned above, can also be adjusted by the manual operation of the operating part 43 in the present embodiment, which increases the convenience of adjustment. It should be noted that, by overturning the holding component 20 upwards, the holding component 20 can only be upwards; by the manual operation of the operating part 43, the holding component 20 can be upwards or downwards.

Alternatively, the triggering part 41 is rotatably connected to the second installation end 30b, and when the operating part 43 is manually lifted, the operating part 43 brings the triggering part 41 to rotate to trigger the release button 60.

As shown in FIG. 11, alternatively, the triggering part 41 is slidably connected to the second installation end 30b, and when the operating part 43 is manually pushed or pulled, the operating part 43 brings the triggering part 41 to move to trigger the release button 60. The operation of the operating part 43, which involves pushing or pulling, is related to the direction of the release button 60. When the release button 60 faces the supporting platform 10, the operating part 43 is pushed manually to trigger the release button 60. When the release button 60 faces away from the supporting platform 10, the operating part 43 is pulled manually to trigger the release button 60.

In addition to the methods mentioned above, when the holding component 20 is overturned upwards, or the holding component 20 is overturned upwards and the operating part 43 is manually lifted, or also the operating part 43 is manually lifted alone as can be seen by the structure described above, it is also possible to trigger the release button and overturn the holding component 20 upwards.

A supporting structure is also provided according to the embodiment of the disclosure. The supporting structure includes a main body, a holding component, a supporting assembly, a releasing component and a limiting component. The holding component is rotatably installed on the main body along the vertical direction, with its upper surface being a holding surface. The supporting assembly is provided at the bottom of the holding component. The supporting assembly includes a first installation end and a second installation end. The first installation end is rotatably connected to the main body, while the second installation end is movably connected to the holding component. A release button is provided at the second installation end of the supporting assembly. When the release button is not triggered, the supporting assembly is used to support the holding component, so that the holding component and the main body remain fixed; and when the release button is triggered by an external force, the supporting assembly is extendable or retractable, so that the holding component is rotatable relative to the main body. The releasing component is movably connected to the second installation end. When an external force is applied to the releasing component, the releasing component moves relative to the second installation end to trigger the release button. The limiting component is installed on the holding component. When the holding component overturns upwards relative to the main body as the holding component is acted upon by a force, the limiting component contacts and drives the releasing component to move relative to the second installation end so as to trigger the release button.

In some embodiments, the releasing component includes a triggering part and an operating part. The triggering part is movably connected to the second installation end. The operating part is connected to the triggering part. Manual operation of the operating part is capable of driving the triggering part to trigger the release button.

In some embodiments, the triggering part is rotatably connected to the second installation end, and when the operating part is manually lifted, the operating part brings the triggering part to rotate to trigger the release button.

In some embodiments, the triggering part is slidably connected to the second installation end, and when the operating part is manually pushed or pulled, the operating part brings the triggering part to move to trigger the release button.

In some embodiments, the second installation end is movably installed to the holding component along the first direction, the releasing component is rotatably installed to the second installation end, the limiting component is located at the bottom of the releasing component, and the first direction is perpendicular to the holding surface. When the holding component overturns upwards relative to the main body as the holding component is acted upon by a force, the limiting component contacts and drives the releasing component to rotate relative to the second installation end to trigger the release button.

In some embodiments, the holding component includes a holding plate and a side plate provided at the bottom of the holding plate, the upper surface of the holding plate is a holding surface. One of the side plate and the second installation end is provided with a first installation hole, the other is provided with a first installation column, and the first installation column is provided through the first installation hole. The first installation hole is an elongated hole extending along a first direction, so that the first installation column is movable along the first direction.

In some embodiments, the releasing component further includes a triggering part, a rod part and an operating part. The triggering part is rotatably connected to the second installation end. The rod part includes a first end and a second end opposite to the first end, the first end of the rod part is connected to the triggering part, and the limiting component is located at the bottom of the rod part. The operating part is connected to the second end of the rod part. Manual operation of the operating part is capable of driving the triggering part to trigger the release button.

In some embodiments, the holding component includes a first connecting end and a first free end, the first connecting end is rotatably connected to the supporting platform, and the operating part is located at the bottom of the first free end.

In some embodiments, the surgical table further includes a top plate installed on top of the holding component, the top plate includes a second connecting end and a second free end, the second connecting end is connected to the holding component, and the operation position is located at the bottom of the second free end.

In some embodiments, the second installation end is movably installed on the holding component along a second direction, and the releasing component is slidably installed on the second installation end along the second direction, and the second direction is the direction in which the holding component extends towards the main body.

In some embodiments, the holding component includes a holding plate and a side plate provided at the bottom of the holding plate, one of the side plate and the second installation end is provided with a second installation hole, the other is provided with a second installation column, and the second installation column is provided through the second installation hole. The second installation hole is an elongated hole extending along the second direction, so that the second installation column is movable along the second direction.

In some embodiments, the releasing component includes a triggering part and a protruding part. The triggering part is slidably installed on the second installation end along the second direction. The protruding part is connected to the triggering part, and the limiting component is located at the side of the protruding part towards the main body.

In some embodiments, the releasing component further includes a rod part. The rod part includes a first end and a second end opposite to the first end, the first end of the rod part is connected to the triggering part, the protruding part is provided at the bottom of the rod part, and the limiting component is provided at the bottom of the rod part.

In some embodiments, the supporting assembly includes a pneumatic supporting member and an installation base. The pneumatic supporting member includes a first end and a second end opposite to the first end, the first end of the pneumatic supporting member is rotatably connected to the main body, and the release button is provided at the second end of the pneumatic supporting member. The installation base is connected to the second end of the pneumatic supporting member and movably installed on the holding component.

A supporting structure is also provided according to the embodiment of the disclosure. The supporting structure includes a main body, a holding component, a supporting assembly and a releasing component. The holding component is rotatably installed on the main body. The supporting assembly is provided at the bottom of the holding component. The supporting assembly includes a first installation end and a second installation end, and the first installation end is rotatably connected to the main body, the second installation end is movably connected to the holding component. A release button is provided at the second installation end of the supporting assembly. When the release button is not triggered, the supporting assembly is used to support the holding component, so that the holding component and the main body remain fixed; and when the release button is triggered by an external force, the supporting assembly is extendable or retractable, so that the holding component is rotatable relative to the main body. The releasing component is movably connected to the second installation end. When an external force is applied to the releasing component, the releasing component moves relative to the second installation end to trigger the release button.

In some embodiments, the releasing component includes a triggering part and an operating part. The triggering part is movably connected to the second installation end. The operating part is connected to the triggering part. Manual operation of the operating part is capable of driving the triggering part to trigger the release button.

In some embodiments, the triggering part is rotatably connected to the second installation end, and when the operating part is manually lifted, the operating part brings the triggering part to rotate to trigger the release button.

In some embodiments, the triggering part is slidably connected to the second installation end, and when the operating part is manually pushed or pulled, the operating part brings the triggering part to move to trigger the release button.

In some embodiments, the surgical table further includes a limiting component. The limiting component is installed on the holding component. When the holding component overturns upwards relative to the main body as the holding component is acted upon by a force, the limiting component contacts and drives the releasing component to move relative to the second installation end to trigger the release button.

In some embodiments, the releasing component is rotatably installed to the second installation end, the limiting component is located at the bottom of the releasing component. When the holding component overturns upwards relative to the main body as the holding component is acted upon by a force, the limiting component contacts and drives the releasing component to rotate relative to the second installation end to trigger the release button.

In some embodiments, the holding component includes a holding plate and a side plate provided at the bottom of the holding plate, the upper surface of the holding plate is a holding surface. One of the side plate and the second installation end is provided with a first installation hole, the other is provided with a first installation column, and the first installation column is provided through the first installation hole. The first installation hole is an elongated hole extending along a first direction, so that the first installation column is movable along the first direction. The first direction is provided at an angle to the holding surface, or the first direction is along the arc of a circular centered at the pivot point where the holding component is hinged to the supporting platform.

In some embodiments, the releasing component further includes a triggering part, a rod part and an operating part. The triggering part is rotatably connected to the second installation end. The rod part includes a first end and a second end opposite to the first end, the first end of the rod part is connected to the triggering part, and the limiting component is located at the bottom of the rod part. The operating part is connected to the second end of the rod part. Manual operation of the operating part is capable of driving the triggering part to trigger the release button.

In some embodiments, the holding component includes a first connecting end and a first free end, the first connecting end is rotatably connected to the supporting platform, and the operating part is located at the bottom of the first free end.

In some embodiments, the surgical table further includes a top plate installed on top of the holding component, the top plate includes a second connecting end and a second free end, the second connecting end is connected to the holding component, and the operation position is located at the bottom of the second free end.

In some embodiments, the holding component includes a first connecting end and a first free end, the first connecting end is rotatably connected to the supporting platform, the second installation end is movably installed on the holding component along the second direction, and the releasing component is slidably installed on the second installation end along the second direction. The second direction is the direction in which the first connecting end extends towards the first free end.

In some embodiments, the holding component includes a holding plate and a side plate provided at the bottom of the holding plate, one of the side plate and the second installation end is provided with a second installation hole, the other is provided with a second installation column, and the second installation column is provided through the second installation hole. The second installation hole is an elongated hole extending along the second direction, so that the second installation column is movable along the second direction.

In some embodiments, the releasing component includes a triggering part and a protruding part. The triggering part is slidably installed on the second installation end along the second direction. The protruding part is connected to the triggering part, and the limiting component is located at the side of the protruding part towards the main body.

In some embodiments, the releasing component further includes a rod part. The rod part includes a first end and a second end opposite to the first end, the first end of the rod part is connected to the triggering part, the protruding part is provided at the bottom of the rod part, and the limiting component is provided at the bottom of the rod part.

In some embodiments, the supporting assembly includes a pneumatic supporting member and an installation base. The pneumatic supporting member includes a first end and a second end opposite to the first end, the first end of the pneumatic supporting member is rotatably connected to the main body, and the release button is provided at the second end of the pneumatic supporting member. The installation base is connected to the second end of the pneumatic supporting member and movably installed on the holding component.

The foregoing descriptions are only the embodiments of the disclosure, but the scope of protection of the disclosure is not limited thereto. Any person skilled in the art may easily conceive of various equivalent modifications or substitutions within the scope of technology disclosed by the disclosure, and these modifications or substitutions shall be covered by the scope of protection of the disclosure. Therefore, the protection scope of the disclosure shall be main body to the scope of protection of the claims.

What is claimed is:

1. A surgical table, comprising:
a supporting platform that is a main body for the surgical table;
a holding component, which is rotatably installed on the supporting platform;
a supporting assembly, which is provided at a bottom of the holding component, and the supporting assembly comprises a first installation end and a second installation end, wherein the first installation end is rotatably connected to the supporting platform and the second installation end is movably connected to the holding component, and a release button is provided at the second installation end of the supporting assembly, wherein when the release button is not triggered, the supporting assembly is used to support the holding component, so that the holding component and the supporting platform remain fixed, and when the release button is triggered by an external force, the supporting assembly is extendable or retractable, so that the holding component is rotatable relative to the supporting platform;
a releasing component, which is movably connected to the second installation end, wherein when an external force is applied to the releasing component, the releasing component moves relative to the second installation end to trigger the release button; and
a limiting component, which is installed on the holding component,
wherein when the holding component overturns relative to the supporting platform as the holding component is acted upon by a force, the limiting component contacts and drives the releasing component to move relative to the second installation end to trigger the release button.

2. The surgical table according to claim 1, wherein the releasing component comprises:
a triggering part, which is movably connected to the second installation end; and
an operating part, which is connected to the triggering part, wherein operation of the operating part is capable of driving the triggering part to trigger the release button.

3. The surgical table according to claim 2, wherein the triggering part is rotatably connected to the second installation end, and when the operating part is lifted, the operating part brings the triggering part to rotate to trigger the release button.

4. The surgical table according to claim 2, wherein the triggering part is slidably connected to the second installation end, and when the operating part is pushed or pulled, the operating part brings the triggering part to move to trigger the release button.

5. The surgical table according to claim 1, wherein the releasing component is rotatably installed on the second installation end, and the limiting component is located at a bottom of the releasing component.

6. The surgical table according to claim 5, wherein the holding component comprises a holding plate and a side plate provided at a bottom of the holding plate, wherein an upper surface of the holding plate is a holding surface, and one of the side plate and the second installation end is provided with a first installation hole, the other is provided with a first installation column, and the first installation column is provided through the first installation hole,
wherein the first installation hole is an elongated hole extending along a first direction, so that the first installation column is movable along the first direction, and wherein the first direction is at an angle with the holding surface; or, the first installation hole is an arc hole.

7. The surgical table according to claim 5, wherein the releasing component comprises:
a triggering part, which is rotatably connected to the second installation end;
a rod part, which comprises a first end and a second end opposite to the first end, wherein the first end of the rod part is connected to the triggering part, and the limiting component is located at a bottom of the rod part; and
an operating part, which is connected to the second end of the rod part, wherein manual operation of the operating part is capable of driving the triggering part to trigger the release button.

8. The surgical table according to claim 7, wherein the holding component comprises a first connection end and a first free end, wherein the first connection end is rotatably connected to the supporting platform, and the operating part is located at a bottom of the first free end; or,
the surgical table further comprises a top plate installed on a top of the holding component, wherein the top plate comprises a second connection end and a second free end, and wherein the second connection end is connected to the holding component, and the operating part is located at a bottom of the second free end.

9. The surgical table according to claim 1, wherein the holding component comprises a first connection end and a first free end, wherein the first connection end is rotatably connected to the supporting platform, and the second installation end is movably installed on the holding component along a second direction, and the releasing component is slidably installed on the second installation end along the second direction, wherein the second direction is a direction along which the first connection end extends towards the first free end.

10. The surgical table according to claim 9, wherein the holding component comprises a holding plate and a side plate provided at a bottom of the holding plate, wherein one of the side plate and the second installation end is provided with a second installation hole, the other is provided with a second installation column, and the second installation column is provided through the second installation hole, wherein the second installation hole is an elongated hole extending along the second direction, so that the second installation column is movable along the second direction.

11. The surgical table according to claim 9, wherein the releasing component comprises:
a triggering part, which is slidingly installed on the second installation end along the second direction; and
a protruding part, which is connected to the triggering part, and the limiting component is located at a side of the protruding part towards the supporting platform.

12. The surgical table according to claim 11, wherein the releasing component further comprises:
a rod part, which comprises a first end and a second end opposite to the first end, wherein the first end of the rod part is connected to the triggering part, and the protruding part is provided at a bottom of the rod part, and the limiting component is provided at the bottom of the rod part.

13. The surgical table according to claim 1, wherein the supporting assembly comprises:
a pneumatic supporting member, which comprises a first end and a second end opposite to the first end, wherein the first end of the pneumatic supporting member is rotatably connected to the supporting platform, and the release button is provided at the second end of the pneumatic supporting member; and
an installation base, which is connected to the second end of the pneumatic supporting member and movably installed on the holding component.

14. A supporting structure, comprising:
a main body;
a holding component, which is rotatably installed on the main body;
a supporting assembly, which is provided at the bottom of the holding component, and the supporting assembly comprises a first installation end and a second installation end, wherein the first installation end is rotatably connected to the main body and the second installation end is movably connected to the holding component, and a release button is provided at the second installation end of the supporting assembly, wherein when the release button is not triggered, the supporting assembly is used to support the holding component, so that the holding component and the main body remain fixed, and when the release button is triggered by an external force, the supporting assembly is extendable or retractable, so that the holding component is rotatable relative to the main body;
a releasing component, which is movably connected to the second installation end, wherein when an external force is applied to the releasing component, the releasing component moves relative to the second installation end to trigger the release button; and
a limiting component, which is installed on the holding component,
wherein when the holding component overturns upwards relative to the main body as the holding component is acted upon by a force, the limiting component contacts and drives the releasing component to move relative to the second installation end to trigger the release button.
